(19) United States
(12) Patent Application Publication
(10) Pub. No.: US 2012/0020491 A1
(43) Pub. Date: Jan. 26, 2012

(54) HEADSET

(76) Inventor: Jon R. Dory, Fort Collins, CO (US)

(21) Appl. No.: 12/839,882

(22) Filed: Jul. 20, 2010

(51) Int. Cl. H04R 1/10

(52) U.S. Cl. 381/74

(57) ABSTRACT

An embodiment of a headset has first and second audio output devices, an audio input device, a boom for positioning the audio input device movable to first and second locations, and a switch assembly responsive to movement of the boom. When the boom is located at the first location, the switch assembly is configured to couple the first audio output device to receive a first signal and the second audio output device to receive a second signal. When the boom is located at the second location, the switch assembly is configured to couple the first audio output device to receive the second signal and the second audio output device to receive the first signal.

### BACKGROUND

Some headsets, such as stereo (e.g., binaural) headsets, include a pair of audio output devices, such as a speakers (e.g., sometimes called a headphones). The speakers are respectively worn over a user's ears. Each speaker receives an electrical audio signal (e.g., sometimes referred to as an audio image) and converts the audio signal into sounds that can be heard by the user. For stereo music applications, an audio signal corresponding to a right audio channel of the music is usually received at a speaker worn over the user's right ear, and an audio signal corresponding to a left audio channel of the music is usually received at a speaker worn over the user's left ear.

Sometimes the stereo audio signals may accompany video images displayed on a video display, e.g., for gaming applications, video conferences, etc. For example, an audio signal that corresponds to a right audio channel, corresponding to a video image displayed on the right side of a video display, is usually received at a speaker worn over the user's right ear, and an audio signal that corresponds to a left audio channel, corresponding to a video image displayed on the left side of a video display, is usually received at a speaker worn over the user's left ear.

Some stereo headsets may include a microphone to enable the user to communicate by converting the user's voice into electrical audio signals for output from the headset. Such headsets are sometimes called communication headsets. For some headsets, the microphone may be located at or near an end of a microphone boom. The boom may be attached to one side (e.g., either the right or left side) of the headset so the boom extends from that side of the headset, and thus the respective side of the user's head, to in front of the user's mouth.

However, some users may prefer that the boom be located so that it extends from an opposite side of their head. Therefore, some headsets are reversible (e.g., sometimes called ambidextrous) so that when worn in a reversed orientation, the speaker normally intended to be worn over the user's right ear is worn over the user's left ear and the speaker normally intended to be worn over the user's left ear is worn over the user's right ear. For some reversible headsets, the position of the microphone boom is adjustable for positioning the microphone in front of the user's mouth when the headset is worn either in its normal or reversed orientation.

### DESCRIPTION OF THE DRAWINGS

FIG. 1 is a perspective view of an embodiment of a headset, according to an embodiment.

FIG. 2 is a right side view of FIG. 1, according to another embodiment.

FIG. 3 is a simplified block diagram of an embodiment of a headset, according to another embodiment.

FIG. 4 is a block diagram illustrating an embodiment of a switch assembly, according to another embodiment.

FIG. 5 illustrates a cut-away view of a portion of an embodiment of an earpiece of a headset, according to another embodiment.

FIG. 6 is a simplified block diagram of an embodiment of a headset, according to another embodiment.

FIG. 7A illustrates a portion of a headset for selectively directing light to sensors of the headset, according to another embodiment.

FIG. 7B is a cross-section taken along line 7B-7B of FIG. 7A.

FIG. 8 illustrates a portion of a microphone boom of a headset, according to another embodiment.

FIG. 9 is presents a flowchart of an embodiment of a method of operating a headset, according to another embodiment.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense.

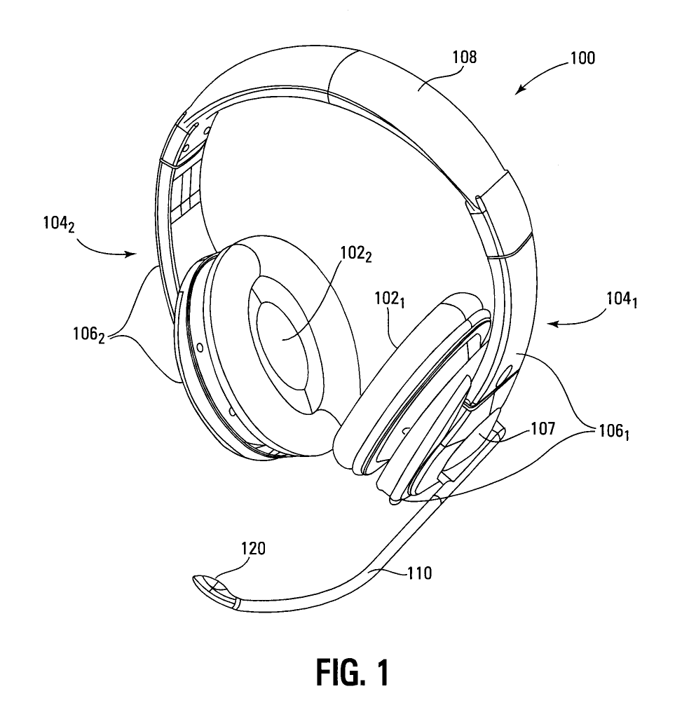

FIG. 1 is a perspective view of an example headset 100, such as a stereo (e.g., binaural) headset, according to an embodiment. Headset 100 includes first and second audio output devices, such as speakers 102₁ and 102₂ (e.g., sometimes called headphones), respectively located on sides 104₁ and 104₂ of headset 100. For some embodiments, speakers 102₁ and 102₂ may respectively form a portion of earpieces 106₁ and 106₂ respectively located on sides 104₁ and 104₂ of headset 100.

Earpieces 106, and thus speakers 102, may be coupled to a band 108, e.g., a headband. For example, earpieces 106 may be located at the respective ends of band 108, e.g., that may be flexible.

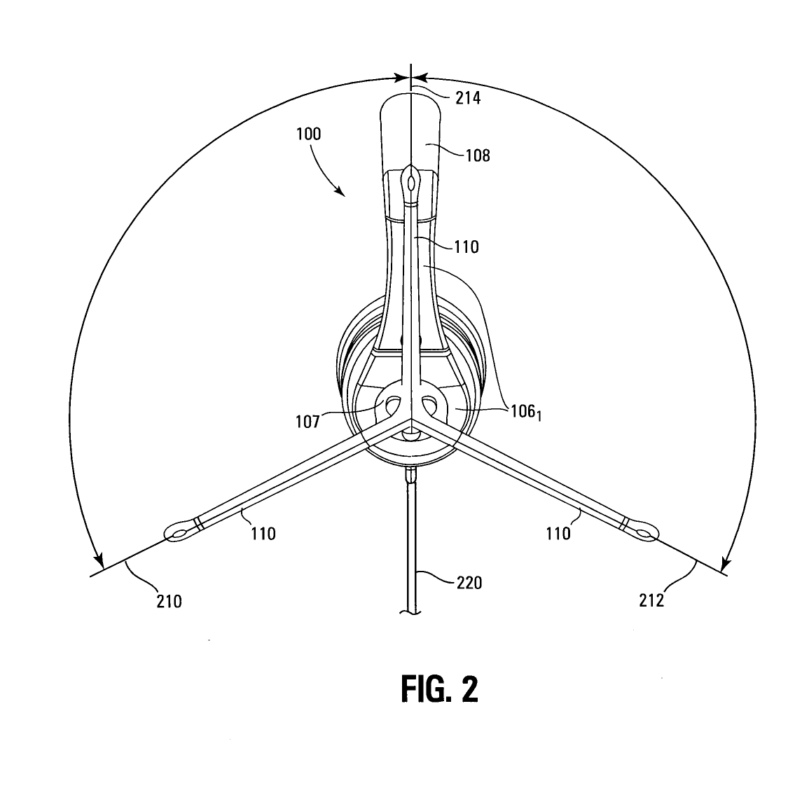

A boom for positioning an audio output device (e.g., a microphone 120), such as a microphone boom 110, may be movably attached to side 104₁. For example, microphone boom 110 may be pivotally attached to earpiece 106₁ for pivoting relative to earpiece 106₁, as shown in FIG. 2, a right side view of FIG. 1. In the example of FIG. 2, microphone boom 110 is movable (e.g., pivotable) clockwise from a location (e.g., angular location) 210, e.g., position 210, to a location (e.g., angular location) 212, e.g., position 212. For example, microphone boom 110 is pivotable counterclockwise from a particular location, such as location (e.g., angular location) 214, e.g., position 214, to location 210 and clockwise from location 214 to location 212. A portion of the microphone boom 110 may be substantially parallel (e.g., parallel) with a portion of earpiece 106₁ at location 214.

Microphone 120 may be located adjacent an end (e.g., a distal end) of microphone boom 110, as shown in FIG. 1, for positioning microphone 120 adjacent (e.g., in front of) a user's mouth. Microphone boom 110 may be flexible so that it can be bent to position microphone 120 adjacent (e.g., in front of) the user's mouth. Note that headsets with microphones are sometimes referred to as communication headsets.

For some embodiments, headset 100 receives electrical audio signals (e.g., sometimes referred to as an audio image) over a cable 220 that are sent to speakers 102, and outputs electrical (e.g., audio) signals from microphone 120 over cable 220. For example, cable 220 may include wires coupled to speakers 102 and wires coupled to microphone 120. Alternatively, for other embodiments, headset 100 may be wireless and may receive wireless electrical audio signals that are sent to speakers 102, and may output wireless electrical audio signals from microphone 120. For example, headset may be configured to be compatible with the Bluetooth protocol or IEEE 802.11b or IEEE 802.11g 2.4 GHz wireless protocol.

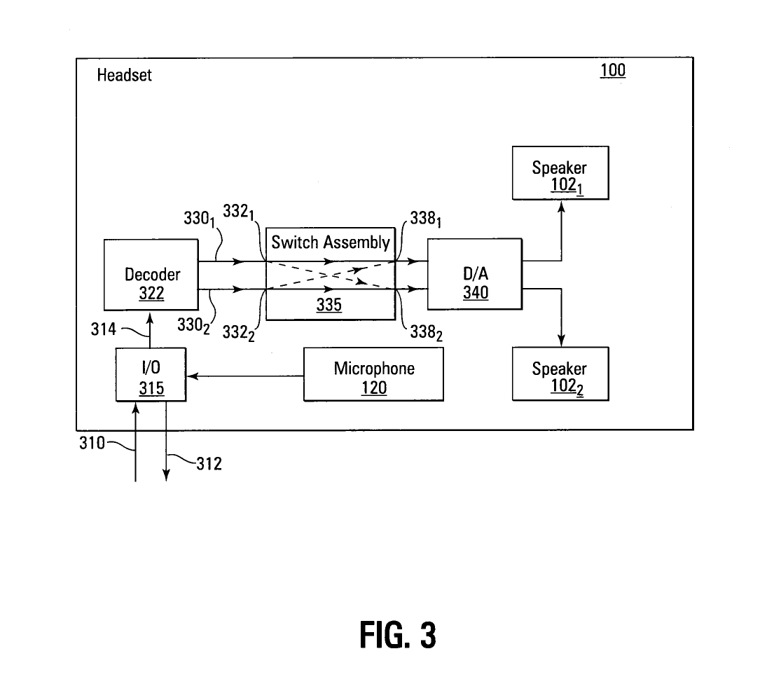

FIG. 3 is a simplified block diagram of headset 100, according to another embodiment. Headset 100 receives an electrical signal (e.g., an audio signal) 310. For example, signal 310 may be an encoded digital signal (e.g., a data signal), corresponding to a pair of audio channels (e.g., a right audio channel and a left audio channel).

For some embodiments, headset 100 may include an input/output (I/O) interface 315. I/O interface 315 may be configured to input signal 310 and output a digital electrical audio signal 312 received from microphone 120. I/O interface 315 may be located within earpiece 106₁.

For some embodiments, I/O interface 315 may be configured to input/output wireless digital signals. For example, I/O interface 315 may be compatible with the Bluetooth protocol or IEEE 802.11b or IEEE 802.11g 2.4 GHz wireless protocol. For other embodiments, I/O interface 315 may be hardwired to cable 220. For example, I/O interface 315 may be integrated within cable 220. I/O interface 315 may be a USB (Universal Serial Bus) interface and cable 220 may be a USB cable.

Headset 100 may include a decoder 322 that is coupled to receive a digital signal 314, corresponding to digital signal 310, from I/O interface 315. Decoder 322 decodes the digital signal 314 received thereat into digital signals 330₁ and 330₂ and outputs (e.g., sends) digital signals 330₁ and 330₂ respectively to inputs 332₁ and 332₂ of a switch assembly 335. For example, digital signals 330₁ and 330₂ may respectively correspond to first and second (e.g., left and right) audio channels, such as first and second audio images.

As is discussed in more detail below, switch assembly 335 is responsive to movement of microphone boom 110. When the microphone boom 110 is located at location 210 or anywhere between location 210 and location 214 (FIG. 2), for some embodiments, switch assembly 335 is in a first state and is configured to direct digital signals 330₁ and 330₂ to a digital-to-analog (D/A) converter 340 that converts digital signals 330₁ and 330₂ to analog signals that are respectively output (e.g., sent) to speakers 102₁ and 102₂ from D/A converter 340. For example, switch assembly 335 may be in the first state when microphone boom 110 is located at location 210 or at any one of a plurality of locations between location 210 and location 214.

When switch assembly 335 in its first state, switch assembly 335 couples input 332₁, and thus digital signal 330₁, to output 338₁ of switch assembly 335 and input 332₂, and thus digital signal 330₂, to output 338₂ of switch assembly 335, as indicated by the solid lines passing through switch assembly 335 in FIG. 3. Note that outputs 338₁ and 338₂ are coupled to digital-to-analog converter 340 and thus respectively to speakers 102₁ and 102₂ through digital-to-analog converter 340.

Stated in another way, when switch assembly 335 in its first state, switch assembly 335 couples input 332₁ to speaker 102₁ and input 332₂ to speaker 102₂. That is, when switch assembly 335 in its first state, switch assembly 335 couples speaker 102₁ to receive the first audio channel corresponding to digital signal 330₁ and speaker 102₂ to receive the second audio channel corresponding to digital signal 330₂.

When the microphone boom 110 is located at location 212 or anywhere between location 212 and location 214 (FIG. 2), for some embodiments, switch assembly 335 is in a second state and is configured to direct digital signals 330₁ and 330₂ through D/A converter 340 that converts digital signals 330₁ and 330₂ to analog signals that are respectively output (e.g., sent) to speakers 102₂ and 102₁ from D/A converter 340. For example, switch assembly 335 may be in the second state when microphone boom 110 is located at location 212 or at any one of a plurality of locations between location 212 and location 214.

When switch assembly 335 in its second state, switch assembly 335 couples input 332₁, and thus digital signal 330₁, to output 338₂ of switch assembly 335 and input 332₂, and thus digital signal 330₂, to output 338₁ of switch assembly 335, as indicated by the dashed lines passing through switch assembly 335 in FIG. 3. Stated in another way when switch assembly 335 in its second state, switch assembly 335 couples input 332₁ to speaker 102₂ and input 332₂ to speaker 102₁. That is, when switch assembly 335 in its second state, switch assembly 335 couples speaker 102₁ to receive the second audio channel corresponding to digital signal 330₂ and speaker 102₂ to receive the first audio channel corresponding to digital signal 330₁.

When switch assembly 335 is in its first state, switch assembly 335 causes an analog signal corresponding to digital signal 330₁ and an analog signal corresponding to digital signal 330₂ to be respectively sent to speakers 102₁ and 102₂, and when switch assembly 335 is in its second state, switch assembly 335 causes an analog signal corresponding to digital signal 330₁ and an analog signal corresponding to digital signal 330₂ to be respectively sent to speakers 102₂ and 102₁.

In an example, digital signals 330₁ and 330₂, and thus the analog signals corresponding thereto, may respectively correspond to left and right audio channels and speakers 102₁ and 102₂ may be respectively worn over a user's left and right ears when microphone boom 110 is at a location, such as location 210, that causes switch assembly 335 to be in its first state, meaning that the analog signals respectively corresponding to digital signals 330₁ and 330₂, and thus the left and right audio channels, are respectively received at speakers 102₁ and 102₂ respectively worn over a user's left and right ears. When the user places microphone boom 110 at a location, such as location 212, that causes switch assembly 335 to be in its second state and the user reverses speakers 102₁ and 102₂ so that they are respectively worn over the user's right and left ears, the analog signals respectively corresponding to digital signals 330₁ and 330₂, and thus the left and right audio channels, are received at speakers 102₂ and 102₁ respectively worn over a user's left and right ears. This means that the left and right channel audio signals are respectively received at the speakers worn over the user's left and right ears, regardless of whether or not the user reverses the headset, which is an advantage over some current headphone sets, where left and right audio channels are received at the speakers respectively worn over a user's right and left ears when the user reverses the headset.

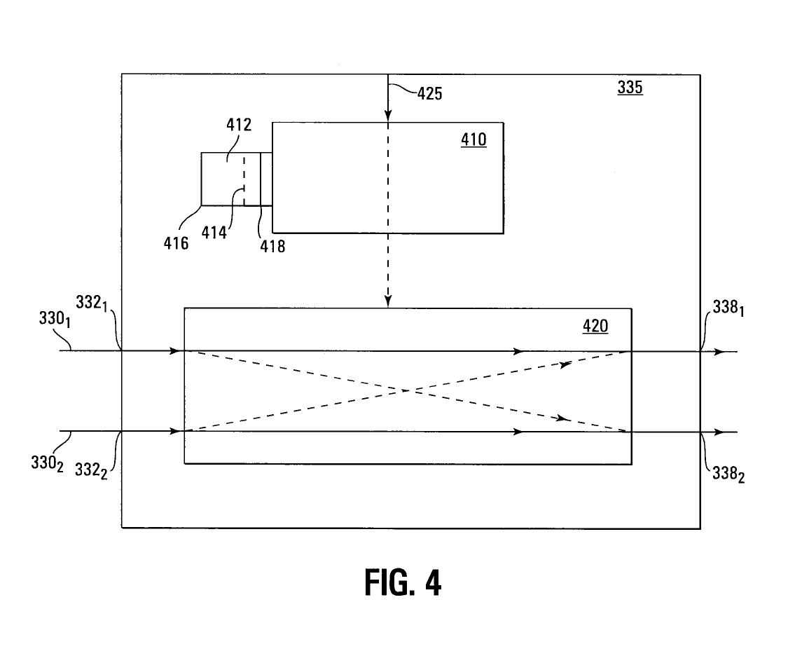

FIG. 4 is a block diagram illustrating an example of switch assembly 335, according to other embodiments. Switch assembly 335 may include a switch 410, such as an on/off switch, having an output electrically coupled to circuitry 420, such as logic circuitry. For example, circuitry 420 may be a general purpose input/output (GPIO) circuit (e.g., device).

Switch 410 may be configured to send an electrical signal 425 (e.g., of about five volts), such as a control signal, to circuitry 420 in response to microphone boom 110 moving to location 210 (FIG. 2) or to a location between locations 210 and 214 and to prevent signal 425 from being sent to circuitry 420 in response to microphone boom 110 moving to location 212 or to a location between locations 212 and 214. For example, moving microphone boom 110 to location 212 or to a location between locations 212 and 214 may cause electrical signal 425 to be removed from circuitry 420.

Switch 410 may include an actuator, such as a movable (e.g., a push) button 412, as shown in FIG. 4, that is selectively engagable with microphone boom 110. In the example, of FIG. 4, when button 412 is located at location 414, switch 410 directs (e.g., sends) signal 425 to circuitry 420, and when button 412 is located at location 416 (e.g., undepressed from location 414), switch 410 prevents signal 425 from being directed (e.g., sent) to circuitry 420, e.g., from being received at circuitry 420, by removing signal 425 from circuitry 420.

In the example of FIG. 4, circuitry 420 places switch assembly 335 in its first state, coupling input 332₁, and thus digital signal 330₁, to output 338₁ and input 332₂, and thus digital signal 330₂, to output 338₂, in response to receiving signal 425. For example, circuitry 420 has a first state that corresponds to (e.g., that is) the first state of switch assembly 335. When circuitry 420 is in its first state, circuitry 420 is configured to direct digital signal 330₁ so that the analog signal corresponding thereto arrives at speaker 102₁ and to direct digital signal 330₂ so that the analog signal corresponding thereto arrives at speaker 102₂, in response to circuitry 420 receiving signal 425. Note that receiving signal 425 at circuitry 420 is analogous to circuitry 420 receiving a logic high (e.g., logic 1) input, and circuitry 420, and thus switch assembly 335, are configured in the first state in response to receiving the logic high input.

When circuitry 420 is prevented from receiving signal 425, circuitry 420 places switch assembly 335 in its second state, coupling input 332₁, and thus digital signal 330₁, to output 338₂ and input 332₂, and thus digital signal 330₂, to output 338₁. For example, circuitry 420 has a second state that corresponds to (e.g., that is) the second state of switch assembly 335. When circuitry 420 is in its second state, circuitry 420 is configured to direct digital signal 330₁ so that the analog signal corresponding thereto arrives at speaker 102₂ and to direct digital signal 330₂ so that the analog signal corresponding thereto arrives at speaker 102₁, in response to switch 410 preventing the signal from being sent to circuitry 420. Note that when circuitry 420 is prevented from receiving signal 425, it is analogous to circuitry 420 receiving a logic low (e.g., logic 0) input, and circuitry 420, and thus switch assembly 335, are configured in the second state in response to receiving the logic low. For example, preventing circuitry 420 from receiving signal 425 corresponds to removing signal 425 and the voltage associated therewith from circuitry 420. It is the removal of signal 425 and the voltage associated therewith that is analogous to circuitry 420 receiving a logic low (e.g., logic 0) input.

Alternatively, circuitry 420 may place switch assembly 335 in its second state in response to receiving signal 425 and place switch assembly 335 in its first state when circuitry 420 is prevented from receiving signal 425.

For some embodiments, switch assembly 335 is configured to switch to the first state in response to microphone boom 110 moving in a first direction (e.g., counterclockwise in the example of FIG. 2) past particular location 214 and to switch to a second state in response to microphone boom 110 moving in a second direction (e.g., clockwise in the example of FIG. 2) past particular location 214.

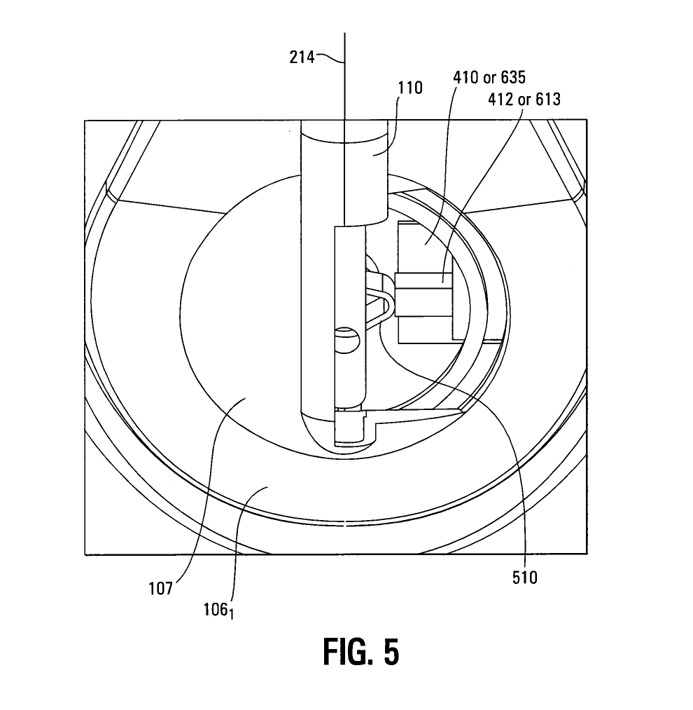

FIG. 5 illustrates a cut-away view of a portion of earpiece 106₁, according to some embodiments. A lobe 510 may extend from microphone boom 110 adjacent an end (e.g., a proximal end) of microphone boom 110 that is opposite the distal end to which microphone 120 is adjacent.

In the example of FIG. 5, upon engaging button 412, lobe 510 depresses button 412 to position 418 (FIG. 4) from position 416 when microphone boom 110 is moving in a direction from location 212 to location 210 (e.g., the counterclockwise direction in the example of FIG. 2). When microphone boom 110 moves past location 214 and lobe 510 disengages button 412, button 412 moves to position 414 and remains there. This means that circuitry 420, and thus switch assembly 335, is configured at its state (e.g., first state) corresponding to when button 412 is at position 414, when microphone boom 110 is located at location 210 or anywhere between location 210 and the location between location 210 and location 214 where button 412 first moves to position 414.

Further in the example of FIG. 5, upon engaging button 412, lobe 510 depresses button 412 to position 418 (FIG. 4) from position 414 when microphone boom 110 is moving in a direction from location 210 to location 212 (e.g., the clockwise direction in the example of FIG. 2). When microphone boom 110 moves past location 214 and lobe 510 disengages button 412, button 412 moves to position 416 and remains there. This means that circuitry 420, and thus switch assembly 335, is configured at its state (e.g., second state) corresponding to when button 412 is at position 416, when microphone boom 110 is located at location 212 or anywhere between location 212 and the location between location 212 and location 214 where button 412 first moves to position 416.

In the examples of FIGS. 3-5, switch 410 may be located within earpiece 106₁. For some embodiments, circuitry 420 may be located on a printed circuit board (not shown). For other embodiments, decoder 322 and/or D/A converter 340 may also be located on that printed circuit board. The printed circuit board may be located within earpiece 106₁, may be located on band 108, or may be integrated within cable 220.

Button 412, and thus switch 410 of switch assembly 335, may be thought of as acting as a sensor that effectively senses the position of microphone boom 110, for some embodiments. For example, when microphone boom 110 is moving in a first direction (e.g., counterclockwise in the example of FIG. 2) past particular location 214 and engages button 412 to place button 412 into position 414 (FIG. 4), button 412 has effectively sensed that microphone boom 110 is located at an angular location anywhere from location 210 to the location between location 210 and location 214 where button 412 first moves to position 414. That is, placing button 412 into position 414 determines that microphone boom 110 is located at an angular location anywhere from location 210 to the location between location 210 and location 214 where button 412 first moves to position 414.

Similarly, when microphone boom 110 is moving in a second direction (e.g., clockwise in the example of FIG. 2) past particular location 214 and engages button 412 to place button 412 into position 416 (FIG. 4), button 412 has effectively sensed that microphone boom 110 is located at an angular location anywhere from location 212 to the location between location 212 and location 214 where button 412 first moves to position 416. That is, placing button 412 into position 416 determines that microphone boom 110 is located at an angular location anywhere from location 212 to the location between location 212 and location 214 where button 412 first moves to position 416.

Therefore, switch assembly 335 is configured to sense (e.g., determine) the location of microphone boom 110. Switch assembly 335 is configured to switch to its first state in response to sensing (e.g. determining) that microphone boom 110 is located at an angular location, at a first angular direction (e.g., counterclockwise in FIG. 2) from location 214, anywhere between location 214 and location 210. Switch assembly 335 is configured to switch to its second state in response to sensing (e.g. determining) that microphone boom 110 is located at an angular location, at a second angular direction (e.g., clockwise in FIG. 2) from location 214, anywhere between location 214 and location 212.

Stated in another way, switch assembly 335 is configured to switch to its first state in response to sensing (e.g. determining) that microphone boom 110 is located at an angular location within a first range of angular locations, e.g., the range from location 210 to the location between location 210 and location 214 where button 412 first moves to position 414, and to switch to its second state in response to sensing (e.g. determining) that microphone boom 110 is located at an angular location within a second range of angular locations, e.g., the range from location 212 to the location between location 212 and location 214 where button 412 first moves to position 416.

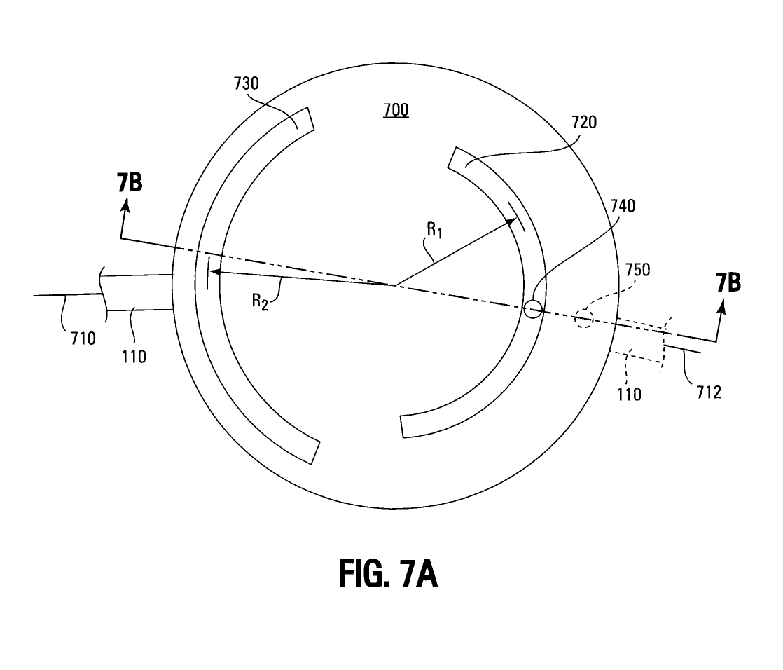

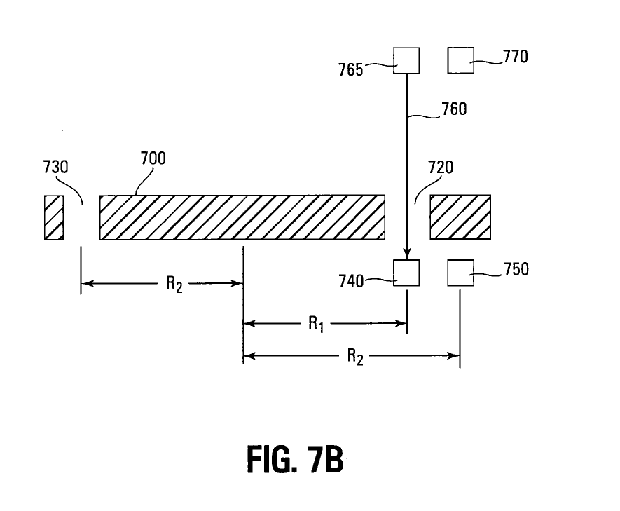

For other embodiments, switch 410 may be activated by electromagnetic radiation, such as light. For such embodiments, microphone boom 110 may be coupled to a disc 700 (FIGS. 7A and 7B), such as a rotor, e.g., located within earpiece 106₁, that rotates as microphone boom 110 is moved. Disc 700 may have an opening 720 therethrough and centered at a radius R₁ and an opening 730 therethrough and centered at a radius R₂, as shown in FIG. 7A and FIG. 7B, a cross-section as viewed along line 7B-7B in FIG. 7A. Disc 700 may be part of switch assembly 335 for some embodiments

When microphone boom 110 is located at location 210 or between locations 210 and 214 (FIG. 2), such as at location 710 in FIG. 7A, an electromagnetic radiation sensor, such as a light sensor 740, located at the radius R₁, e.g., within earpiece 106₁, is aligned with opening 720. When opening 720 is aligned with light sensor 740, light sensor 740 receives a beam of light 760 from a light source 765 (e.g., LED) through opening 720. Light sensor 740 may output an electrical signal, in response to light sensor 740 receiving the beam of light 760, to switch 410 that causes switch 410 to output signal 425. When opening 720 is aligned with light sensor 740, disc 700 covers an electromagnetic radiation sensor, such as a light sensor 750, located at the radius R₂, e.g., within earpiece 106₁, preventing light sensor 750 from receiving light. Sensors 740 and 750 may be part of switch assembly 335 for some embodiments.

When microphone boom 110 is located at location 212 or between locations 212 and 214 (FIG. 2), such as at location 712 in FIG. 7, light sensor 750 is aligned with opening 730, and disc 700 covers light sensor 740, preventing light sensor 740 from receiving light. When opening 730 is aligned with light sensor 750, light sensor 750 receives a beam of light. Light sensor 750 may output an electrical signal, in response to light sensor 750 receiving the beam of light, to switch 410 that causes switch 410 to prevent signal 425 from being output in response to light sensor 750 receiving the beam of light. The beam of light received at light sensor 750 may be received from the light source 765 or a separate light source 770 (e.g., LED).

Sensors 740 and 750 effectively sense the position of microphone boom 110. For example, when sensor 740 receives the beam of light, microphone boom 110 is located within the range of angular locations between locations 210 and 214 (FIG. 2), and when sensor 750 receives the beam of light, microphone boom 110 is located within the range of angular locations between locations 212 and 214.

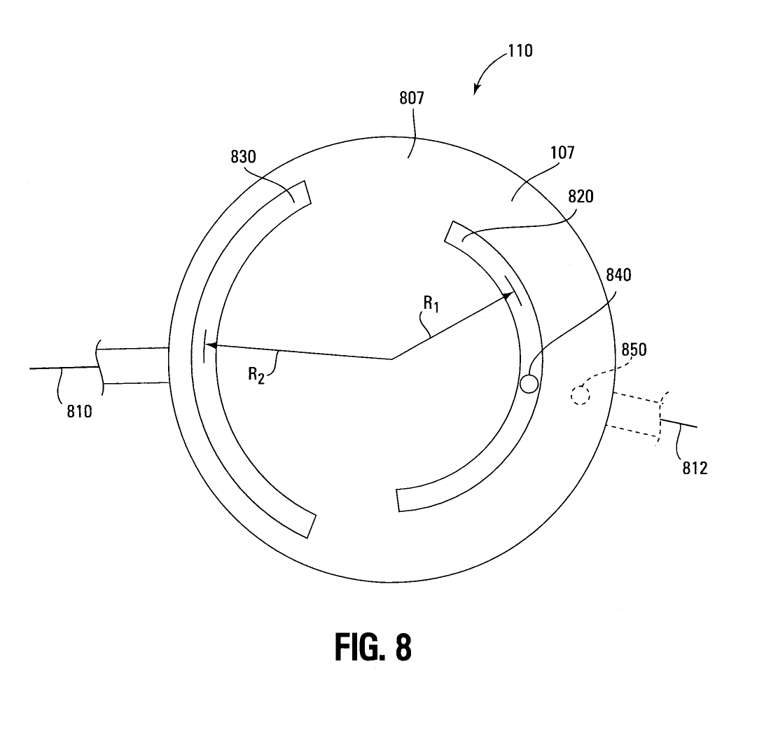

For some embodiments, microphone boom 110 may include a disc 107, such as a rotor, as shown in FIGS. 1, 2, 5, and 8, that rotates as microphone boom 110 is moved. Electrical conductors (e.g., conductive strips) 820 and 830 may be located on an interior surface 807 of disc 107 and may be respectively centered at a radii R₁ and R₂, as shown in FIG. 8.

When microphone boom 110 is located at location 210 or between locations 210 and 214 (FIG. 2), such as at location 810 in FIG. 8, a sensor 840 (located at the radius R₁) that may be part of switch assembly 335, e.g. within earpiece 106₁, is contacted by conductor 820. When conductor 820 contacts sensor 840, sensor 840 outputs (e.g., sends) an electrical signal, in response to conductor 820 contacting sensor 840, to switch 410 that causes switch 410 to output signal 425 in response to switch 410 receiving the electrical signal. When microphone boom 110 is located at location 212 or between locations 212 and 214 (FIG. 2), such as at location 812 in FIG. 8, a sensor 850 (located at the radius R₂) that may be part of switch assembly 335, e.g. within earpiece 106₁, is contacted by conductor 830. When conductor 830 contacts sensor 850, sensor 850 outputs (e.g. sends) an electrical signal, in response to conductor 830 contacting sensor 850, to switch 410 that causes switch 410 to prevent signal 425 from being output in response to switch 410 receiving the electrical signal.

Sensors 840 and 850 effectively sense the position of microphone boom 110. For example, when sensor 840 is in contact with conductor 820, microphone boom 110 is located within the range of angular locations between locations 210 and 214, and when sensor 850 is in contact with conductor 830, microphone boom 110 is located within the range of angular locations between locations 212 and 214.

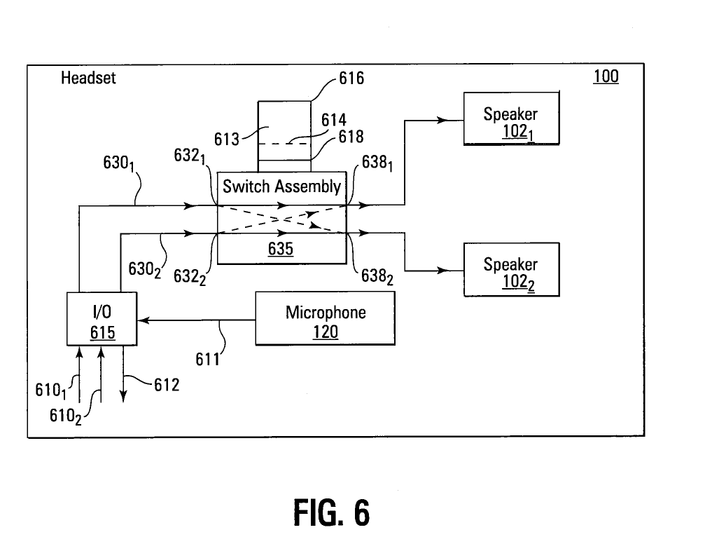

FIG. 6 is a simplified block diagram of headset 100, according to another embodiment. Switch assembly 635 of headset 100 receives analog electrical audio signals 630₁ and 630₂. For example, analog signals 630₁ and 630₂ may respectively correspond to the first and second audio channels (e.g., respectively the left audio channel and the right audio channel). For some embodiments, analog signals 630₁ and 630₂ may be output from an I/O interface 615 configured to receive wireless analog electrical audio signals 610₁ and 610₂, respectively corresponding to analog signals 630₁ and 630₂. For example, I/O interface 615 may be compatible with the Bluetooth protocol or IEEE 802.11b or IEEE 802.11g 2.4 GHz wireless protocol. Alternatively, for other embodiments, analog signals 630₁ and 630₂ may be received from cable 208 (FIG. 2) that may include wires hardwired directly to switch assembly 635.

Microphone 120 may be configured to output an analog electrical audio signal 611 directly through wires in cable 208 that may be hardwired directly to microphone 120. Alternatively, for other embodiments, analog electrical signal 611 may be received from microphone 120 at I/O interface 615. I/O interface 615 may output a wireless analog electrical audio signal 612 corresponding to analog signal 611.

Switch assembly 635 is responsive to movement of microphone boom 110. When the microphone boom 110 is located in location 210 or anywhere between location 210 and location 214 (FIG. 2), for some embodiments, switch assembly 635 is in a first state and is configured to respectively direct analog signals 630₁ and 630₂ to speakers 102₁ and 102₂. When switch assembly 635 in its first state, switch assembly 635 couples input 632₁, and thus analog signal 630₁, to output 638₁ of switch assembly 635 and input 632₂, and thus analog signal 630₂, to output 638₂ of switch assembly 635, as indicated by the solid lines passing through switch assembly 635 in FIG. 6.

Stated another way, when switch assembly 635 in its first state, switch assembly 635 couples input 632₁ to speaker 102₁ and input 632₂ to speaker 102₂. That is, when switch assembly 635 in its first state, switch assembly 635 couples speaker 102₁ to receive the first audio channel corresponding to analog signal 630₁ and speaker 102₂ to receive the second audio channel corresponding to analog signal 630₂.

When the microphone boom 110 is located in location 212 or anywhere between location 212 and location 214 (FIG. 2), for some embodiments, switch assembly 635 is in a second state and is configured to direct analog signals 630₁ and 630₂ respectively to speakers 102₂ and 102₁. When switch assembly 635 in its second state, switch assembly 635 couples input 632₁, and thus analog signal 630₁, to output 638₂ of switch assembly 635 and input 632₂, and thus analog signal 630₂, to output 638₁ of switch assembly 635, as indicated by the dashed lines passing through switch assembly 635 in FIG. 6.

Stated another way, when switch assembly 635 in its second state, switch assembly 635 couples input 632₁ to speaker 102₂ and input 632₂ to speaker 102₁. That is, when switch assembly 635 in its second state, switch assembly 635 couples speaker 102₁ to receive the second audio channel corresponding to analog signal 630₂ and speaker 102₂ to receive the first audio channel corresponding to analog signal 630₁.

Switch assembly 635 may be a two-position switch for some embodiments. For example, when switch assembly 635 is in a first position, switch assembly 635 is in its first state and when switch assembly is in a second position, switch assembly 635 is in its second state.

Switch assembly 635 may include an actuator, such as a movable (e.g., a push) button 613, as shown in FIG. 6, that is selectively engagable with microphone boom 110. In the example of FIG. 6, when button 613 is located at location 614, switch assembly 635 is in its first position, and thus in its first state, and when button 613 is located at location 616 (e.g., undepressed from location 614), switch assembly 635 is in its second position, and thus in its second state.

For some embodiments, switch assembly 635 is configured to switch to the first state in response to microphone boom 110 moving in a first direction (e.g., counterclockwise in the example of FIG. 2) past particular location 214 and to switch to a second state in response to microphone boom 110 moving in a second direction (e.g., clockwise in the example of FIG. 2) past particular location 214.

In the example of FIG. 5, upon engaging button 613, lobe 510 depresses button 613 to position 618 (FIG. 6) from position 616 when microphone boom 110 is moving in a direction from location 212 to location 210 (e.g., the counterclockwise direction in the example of FIG. 2). When microphone boom 110 moves past location 214 and lobe 510 disengages button 613, button 613 moves to position 614 and remains there. This means that switch assembly 635 is configured at its state (e.g., first state) corresponding to when button 613 is at position 614, when microphone boom 110 is located at location 210 or anywhere between location 210 and the location between location 210 and location 214 where button 613 first moves to position 614.

Further in the example of FIG. 5, upon engaging button 613, lobe 510 depresses button 613 to position 618 (FIG. 6) from position 614 when microphone boom 110 is moving in a direction from location 210 to location 212 (e.g., the clockwise direction in the example of FIG. 2). When microphone boom 110 moves past location 214 and lobe 510 disengages button 613, button 613 moves to position 616 and remains there. This means that switch assembly 635 is configured at its state (e.g., second state) corresponding to when button 613 is at position 616, when microphone boom 110 is located at location 212 or anywhere between location 212 and the location between location 212 and location 214 where button 613 first moves to position 616.

In an example, analog signals 630₁ and 630₂ may respectively correspond to left and right audio channels and speakers 102₁ and 102₂ may be respectively worn over a user's left and right ears when microphone boom 110 is at a location, such as location 210, that causes switch assembly 635 to be in (e.g., that places switch assembly 635 in) its first state, meaning that analog signals 630₁ and 630₂, and thus the left and right audio channels, are respectively received at speakers 102₁ and 102₂ respectively worn over the user's left and right ears. When the user places microphone boom 110 at a location, such as location 212, that causes switch assembly 635 to be in (e.g., that places switch assembly 635 in) its second state and the user reverses speakers 102₁ and 102₂ so that they are respectively worn over the user's right and left ears, the analog signals 630₁ and 630₂, and thus the left and right audio channels, are received at speakers 102₂ and 102₁ respectively worn over a user's left and right ears. This means that the left and right channel audio signals are respectively received at the speakers worn over the user's left and right ears, regardless of whether or not the user reverses the headset, which is an advantage over some current headphone sets, where left and right audio channels are received at the speakers respectively worn over a user's right and left ears when the user reverses the headset.

Button 613 may be thought of as acting as a sensor that effectively senses the position of microphone boom 110. For example, when microphone boom 110 is moving in a first direction (e.g., counterclockwise in the example of FIG. 2) past particular location 214 and engages button 613 to place button 613 into position 614 (FIG. 6), button 613 has effectively sensed that microphone boom 110 is located at an angular location anywhere from location 210 to the location between location 210 and location 214 where button 613 first moves to position 614. That is, placing button 613 into position 614 determines that that microphone boom 110 is located at an angular location anywhere from location 210 to the location between location 210 and location 214 where button 613 first moves to position 614.

Similarly, when microphone boom 110 is moving in a second direction (e.g., clockwise in the example of FIG. 2) past particular location 214 and engages button 613 to place button 613 into position 616 (FIG. 6), button 613 has effectively sensed that microphone boom 110 is located at an angular location anywhere from location 212 to the location between location 212 and location 214 where button 613 first moves to position 616. That is, placing button 613 into position 616 determines that that microphone boom 110 is located at an angular location anywhere from location 212 to the location between location 212 and location 214 where button 613 first moves to position 616.

Therefore, switch assembly 635 is configured to sense (e.g., determine) the location of microphone boom 110. Switch assembly 635 is configured to switch to its first state in response to sensing (e.g. determining) that microphone boom 110 is located at an angular location, at a first angular direction (e.g., counterclockwise in FIG. 2) from location 214, anywhere between location 214 and location 210 and to switch to its second state in response to sensing (e.g. determining) that microphone boom 110 is located at an angular location, at a second angular direction (e.g., clockwise in FIG. 2) from location 214, anywhere between location 214 and location 212.

Stated another way, assembly 635 is configured to switch to its first state in response to sensing (e.g. determining) that microphone boom 110 is located at an angular location within a first range of angular locations, e.g., the range from location 210 to the location between location 210 and location 214 where button 613 first moves to position 614, and to switch to its second state in response to sensing (e.g. determining) that microphone boom 110 is located at an angular location within a second range of angular locations, e.g., the range from location 212 to the location between location 212 and location 214 where button 613 first moves to position 616.

For other embodiments, switch assembly 635 may be activated by electromagnetic radiation, such as light, e.g., using disc 700 in conjunction with light sensors 740 and 750, e.g., in a manner similar to that described above in conjunction with FIGS. 7A and 7B. For example, when opening 720 is aligned with light sensor 740, light sensor 740 receives the beam of light and outputs an electrical signal, in response to light sensor 740 receiving the beam of light, to switch assembly 635 that causes switch assembly 635 to switch to its first state. When opening 730 is aligned with light sensor 750, light sensor 750 receives the beam of light and outputs an electrical signal, in response to light sensor 750 receiving the beam of light, to switch assembly 635 that causes switch assembly 635 to switch to its second state. Disc 700 and/or sensors 740 and 750 may be part of switch assembly 635 in some embodiments, meaning that switch assembly may be configured to sense the position microphone boom 110, in that sensors 740 and 750 may effectively sense the position of microphone boom 110, as indicated above in conjunction with FIGS. 7A and 7B.

For some embodiments, switch assembly 635 is placed in its first state when conductor 820 is in contact with sensor 840 and in its second state when conductor 830 is in contact with sensor 850 (FIG. 8). For example, when sensor 840 is in contact with conductor 820, switch assembly 635 receives a first electrical signal from sensor 840, in response to conductor 820 contacting sensor 840, that places switch assembly 635 in its first state, and when a sensor 850 is in contact with conductor 830, switch assembly 635 receives an electrical signal from sensor 850, in response to conductor 830 contacting sensor 850, that places switch assembly 635 in its second state. Sensors 840 and 850 may be part of switch assembly 635 for some embodiments, meaning that switch assembly may be configured to sense the position microphone boom 110, in that sensors 840 and 850 may effectively sense the position of microphone boom 110, as indicated above in conjunction with FIG. 8.

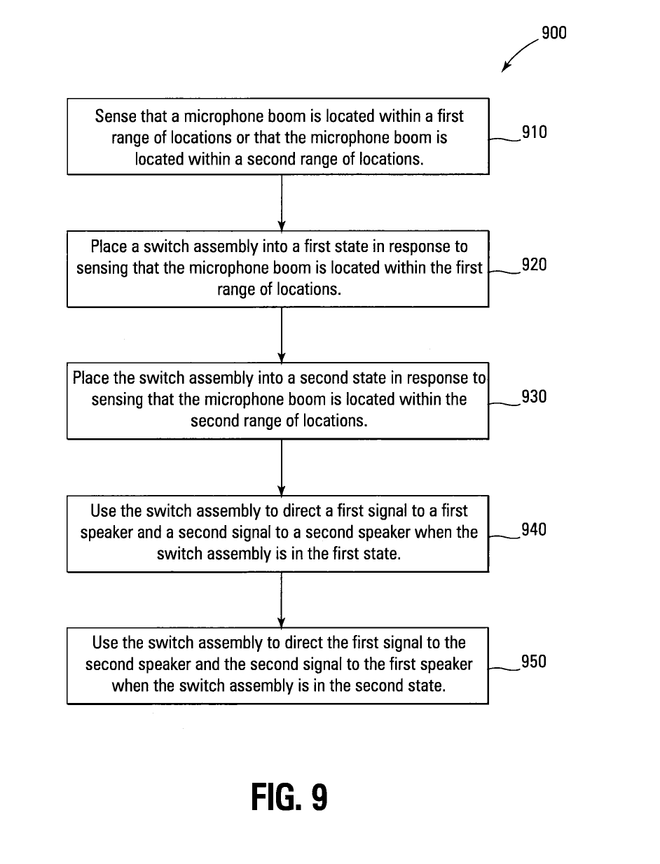

FIG. 9 presents a flowchart of an example method 900 for operating a headset, such as headset 100. At block 910, the method senses that a microphone boom (e.g., microphone boom 110) is located within a first range of locations or that the microphone is located within a second range of locations. A switch assembly (e.g., switch assembly 335 or switch assembly 635) of the headset is placed into a first state in response to sensing that the microphone boom is located within the first range of locations, at block 920. The switch assembly is placed into a second state in response to sensing that the microphone boom is located within the second range of locations, at block 930. The switch assembly is used to direct a first signal to a first speaker (e.g., speaker 102₁) of the headset and a second signal to a second speaker (e.g., speaker 102₂) of the headset when the switch assembly is in the first state, at block 940. The switch assembly is used to direct the first signal to the second speaker and the second signal to the first speaker when the switch assembly is in the second state, at block 950.

Sensing that microphone boom is located within the first range of locations may include engaging an actuator (e.g., button 412 or button 613) of the switch assembly with the microphone boom to place the actuator into a first position (e.g., position 414 of button 412 or position 614 of button 613), and sensing that the microphone boom is located within the second range of locations may include engaging the actuator of the switch assembly with the microphone boom to place the actuator into a second position (e.g., position 416 of button 412 or position 616 of button 613). For some embodiments, the switch assembly is placed into the first state in response to the microphone boom placing the actuator into the first position, and the switch assembly is placed into the second state in response to the microphone boom placing the actuator into the second position.

Sensing that microphone boom is located within the first range of locations may include the microphone boom allowing a first light beam (e.g., light beam 760) to be received at a sensor (e.g., sensor 740) of the headset when the microphone boom is located within the first range of locations, and sensing that microphone boom is located within the second range of locations may include the microphone boom allowing a second light beam to be received at another sensor (e.g., sensor 750) of the headset when the microphone boom is located within the second range of locations. For some embodiments, the switch assembly is placed into the first state in response to receiving a signal at the switch assembly from sensor 740 in response to the sensor 740 receiving the first light beam, and the switch assembly is placed into the second state in response to receiving a signal at the switch assembly from the sensor 750 in response to sensor 750 receiving the second light beam.

Sensing that microphone boom is located within the first range of locations may include the microphone boom contacting a sensor (e.g., sensor 840) of the headset when the microphone boom is located within the first range of locations, and sensing that microphone boom is located within the second range of locations may include the microphone boom contacting another sensor (e.g., sensor 850) of the headset when the microphone boom is located within the second range of locations. For some embodiments, the switch assembly is placed into the first state in response to receiving a signal at the switch assembly from sensor 840 in response to the microphone boom contacting sensor 840, and the switch assembly is placed into the second state in response to receiving a signal at the switch assembly from sensor 850 in response to the microphone boom contacting sensor 850.

The present embodiments advantageously provide headsets that allow speakers worn over a user's right and left ears to respectively receive right and left audio channels when the headset is worn in an orientation where a portion of a microphone boom of the headset is located on one side of the user's head and when the headset is worn in a reversed orientation, where the location of the speakers on the user's head is reversed and where the portion of the microphone boom of the headset is located on the opposite side of the user's head. This is an advantage over some current headsets that respectively receive right and left audio channels at speakers respectively worn over a user's left and right ears, i.e., the respective audio channels are respectively received at ears opposite from which respective audio channels are originally intended, when the headsets are worn in a reversed orientation.

In the present embodiments, moving the microphone boom so that the microphone is positioned adjacent (e.g., in front of) the user's mouth when the microphone boom is located on the opposite side of the user's head when the headset is worn in the reversed orientation switches the right and left channels so that user's right and left ears to respectively receive right and left audio channels when the headset is worn in the reversed orientation. This enables the headset to be independent of the system or specific application with which it is being used, since the switching is performed on the headset. This is an advantage over systems that use application-specific software for reversing stereo audio signals when a headset is worn in a reversed orientation, where switching the channels is dependent on systems with the application-specific software, meaning that the switching will not occur if the headset is used with systems without the application-specific software.

### CONCLUSION

Although specific embodiments have been illustrated and described herein it is manifestly intended that the scope of the claimed subject matter be limited only by the following claims and equivalents thereof.

What is claimed is:

1. A headset, comprising:
first and second audio output devices;
an audio input device;
a boom for positioning the audio input device movable to first and second locations; and
a switch assembly responsive to movement of the boom;
wherein when the boom is located at the first location, the switch assembly is configured to couple the first audio output device to receive a first signal and the second audio output device to receive a second signal; and
wherein when the boom is located at the second location, the switch assembly is configured to couple the first audio output device to receive the second signal and the second audio output device to receive the first signal.

2. The headset of claim 1, further comprising first and second earpieces, wherein the first earpiece comprises the switch assembly and the first audio output device and the second earpiece comprises the second audio output device.

3. The headset of claim 2, wherein the boom is pivotally coupled to the first earpiece.

4. The headset of claim 1, wherein the switch assembly comprises logic circuitry, wherein the logic circuitry is configured to couple the first audio output device to receive the first signal and the second audio output device to receive the second signal in response to receiving a logic high when the boom is located at the first location, and wherein the logic circuitry is configured to couple the first audio output device to receive the second signal and the second audio output device to receive the first signal in response to receiving a logic low when the boom is located at the second location.

5. The headset of claim 1, wherein the switch assembly comprises:
a switch; and
circuitry coupled to the switch;
wherein the switch is configured to send a third signal to the circuitry in response to the boom moving to the first position;
wherein the switch is configured to prevent the third signal from being sent to the circuitry in response to the boom moving to the second position;
wherein the circuitry is configured to couple the first audio output device to receive the first signal and the second audio output device to receive the second signal in response to receiving the third signal from the switch; and
wherein the circuitry is configured to couple the first audio output device to receive the second signal and the second audio output device to receive the first signal in response to the switch preventing the signal from being sent to the circuitry.

6. The headset of claim 1, wherein the switch assembly is configured to couple the first audio output device to receive the first signal and the second audio output device to receive the second signal in response to the switch assembly receiving a light beam at a first sensor when the boom is located at the first location and is configured to couple the first audio output device to receive the second signal and the second audio output device to receive the first signal in response to the switch assembly receiving a light beam at a second sensor when the boom is located at the second location.

7. The headset of claim 1, wherein the switch assembly is configured to couple the first audio output device to receive the first signal and the second audio output device to receive the second signal in response to the boom engaging a first sensor when the boom is located at the first location and is configured to couple the first audio output device to receive the second signal and the second audio output device to receive the first signal in response to the boom engaging a second sensor when the boom is located at the second location.

8. The headset of claim 1, wherein the first and second signals are digital signals, and further comprising:
a digital-to-analog converter coupled between the switch and the first and second speakers and configured to convert the first and second signals to analog signals before the first and audio output devices to receive the first and second signals; and
a decoder coupled to the switch and configured to receive an encoded digital signal, decode the encoded digital signal into the first and second signals, and to output the first and second signals to the switch assembly.

9. The headset of claim 1, wherein the switch assembly is configured to sense whether the boom is located within a first range of locations that comprises the first location and to sense whether the boom is located within a second range of locations that comprises the second location.

10. A headset, comprising:
a first speaker;
a second speaker;
a movable microphone boom; and
a switch assembly configured to determine whether the microphone boom is located within a first range of locations or whether the microphone is located within a second range of locations;
wherein the switch assembly is configured to switch to a first state in response to determining that the microphone boom is located within the first range of locations and to switch to a second state in response to determining that the microphone boom is located within the second range of locations;
wherein when the switch assembly is in the first state, the switch directs a first signal to the first speaker and a second signal to the second speaker; and
wherein when the switch assembly is in the second state the switch directs the first signal to the second speaker and the second signal to the first speaker.

11. The headset of claim 10, wherein the switch determines that the microphone boom is located within the first range of locations in response to the microphone boom engaging an actuator of switch assembly to place the actuator at a first position and wherein the switch determines that the microphone boom is located within the second range of locations in response to the microphone boom engaging the actuator of switch assembly to place the actuator at a second position.

12. The headset of claim 10, wherein the switch determines that the microphone boom is located within the first range of locations in response to the microphone boom allowing a light beam to be received at a first sensor when the microphone boom is located within a first range of locations and wherein the switch determines that the microphone boom is located within the second range of locations in response to the microphone boom allowing a light beam to be received at a second sensor when the microphone boom is located within a second range of locations.

13. The headset of claim 10, wherein the switch determines that the microphone boom is located within the first range of locations in response to the microphone boom engaging a first sensor when the microphone boom is located within the first range of locations and wherein the switch determines that the microphone boom is located within the second range of locations in response to the microphone boom engaging a second sensor when the microphone boom is located within the second range of locations.

14. A method of operating a headset, comprising:
sensing that a microphone boom of the headset is located within a first range of locations or that the microphone boom is located within a second range of locations;
placing a switch assembly of the headset into a first state in response to sensing that microphone boom is located within the first range of locations;
placing the switch assembly into a second state in response to sensing that microphone boom is located within the second range of locations;
using the switch assembly to direct a first signal to a first speaker of the headset and a second signal to a second speaker of the headset when the switch assembly is in the first state; and
using the switch assembly to direct the first signal to the second speaker and the second signal to the first speaker when the switch assembly is in the second state.

15. The method of claim 14, wherein sensing that microphone boom is located within the first range of locations comprises engaging an actuator of the switch assembly with the microphone boom to place the actuator into a first position and wherein sensing that microphone boom is located within the second range of locations comprises engaging the actuator of the switch assembly with the microphone boom to place the actuator into a second position.

16. The method of claim 15, further comprising:
placing the switch assembly in the first state in response to the microphone boom placing the actuator into the first position; and
placing the switch assembly in the second state in response to the microphone boom placing the actuator into the second position.

17. The method of claim 14, wherein sensing that microphone boom is located within the first range of locations comprises the microphone boom allowing a first light beam to be received at a first sensor when the microphone boom is located within the first range of locations and wherein sensing that microphone boom is located within the second range of locations comprises the microphone boom allowing a second light beam to be received at a second sensor when the microphone boom is located within the second range of locations.

18. The method of claim 17, further comprising:
placing the switch assembly in the first state in response to receiving a signal at the switch assembly from the first sensor in response to the first sensor receiving the first light beam; and
placing the switch assembly in the second state in response to receiving a signal at the switch assembly from the second sensor in response to the second sensor receiving the second light beam.

19. The method of claim 14, wherein sensing that microphone boom is located within the first range of locations comprises the microphone boom contacting a first sensor when the microphone boom is located within the first range of locations and wherein sensing that microphone boom is located within the second range of locations comprises the microphone boom contacting a second sensor when the microphone boom is located within the second range of locations.

20. The method of claim 19, further comprising:
placing the switch assembly into the first state in response to receiving a signal at the switch assembly from the first sensor in response to the microphone boom contacting the first sensor; and
placing the switch assembly into the second state in response to receiving a signal at the switch assembly from the second sensor in response to the microphone boom contacting the second sensor.
